(19) United States
(12) Patent Application Publication
(10) Pub. No.: US 2010/0061191 A1
(43) Pub. Date: Mar. 11, 2010

(54) Silent time reminding device

(76) Inventor: Mike Chen, Irvine, CA (US)

Correspondence Address: BACON & THOMAS, PLLC, 625 SLATERS LANE, FOURTH FLOOR, ALEXANDRIA, VA, 22314-1176, US

(21) Appl. No.: 12/230,974

(22) Filed: Sep. 9, 2008

(51) Int. Cl. G04B 37/18; G04F 10/00

(52) U.S. Cl. 368/109; 368/282

(57) ABSTRACT

A silent time reminding device including a soft elastic fastening band and a main body. The fastening band can be fitted on a suitable part of human body. A clipped section is disposed on an outer face of the fastening band to define a pocket with the fastening band. At least one setting key and a resilient clip are disposed on the main body. The resilient clip can be easily extended into the pocket to clip the clipped section so as to detachably associate the main body with the fastening band. A user can wear the fastening band with the main body contacting a surface of the user's body. The main body is at least inbuilt with a timer and a vibration module. At a specific time, the timer drives the vibration module to vibrate for shocking the surface of the user's body to achieve a reminding effect.

### BACKGROUND OF THE INVENTION

The present invention is related to a simple silent time reminding device, and more particularly to a silent time reminding device, which can be easily assembled/disassembled and conveniently used.

There are many kinds of conventional time reminding devices nowadays. Some of these time reminding devices, for example, alarm clocks, are often seen and used in our daily lives. Basically, a conventional time reminding device is inbuilt with a timer and a buzzer. At a preset time, the timer drives the buzzer to emit a reminding sound for reminding a user to do a specific thing. However, such conventional time reminding device is unable to solely remind a specific user. That is, the reminding sound emitted by the buzzer will at the same time affect other irrelevant people in the surrounding. For example, in the case that one of several roommates uses an alarm clock, the alarm emitted from the alarm clock will also wake up other roommates at the same time.

To solve the above problem, many types of silent time reminding devices have been developed. A most often seen product of these devices includes a host with timing function and a vibration alarm unit connected to the host via a conductive wire. The vibration alarm unit will vibrate to touch and shock a surface of human body at a specific time so as to achieve a time reminding effect. However, the vibration alarm unit connected to the host via the conductive wire. Therefore, due to the limitation of the length of the conductive wire, the vibration alarm unit cannot be located in a position too far away from the host. Moreover, the conductive wire is likely to tangle and knot or even break due to unexpected external pulling force. Therefore, it is inconvenient to use such silent time reminding device.

On the other hand, U.S. Patent Pub. No. US2003/0117272 A1, entitled “system and method of silent alarm”, discloses a silent alarm. The silent alarm includes a timekeeping device and a silent alarm signaling device, which are separated from each other. The timekeeping device includes a processor and a wireless data transmitter connected to the processor. The silent alarm signaling device is combined with a user. The silent alarm signaling device includes an internal wireless data receiver. At a preset reminding time, the processor makes the wireless data transmitter transmits an RF signal. The RF signal is received by the wireless data receiver in the silent alarm signaling device. At this time, the silent alarm signaling device generates a tactile alarm for silently reminding a specific user of the time without interfering with any other irrelevant people in the surrounding. The above silent alarm system has a quite complicated structure and includes numerous components. Therefore, the manufacturing cost of such silent alarm system is relatively high. This is not economic. Moreover, the silent alarm signaling device is always controlled by the timekeeping device and cannot be solely used. This limits portability of the silent alarm system and makes it inconvenient to use the silent alarm system.

### SUMMARY OF THE INVENTION

It is therefore a primary object of the present invention to provide a simple silent time reminding device. The silent time reminding device is removably fitted on a part of main body in contact therewith. The silent time reminding device can be easily disassembled and conveniently used without interfering with any other irrelevant people in the surrounding.

It is a further object of the present invention to provide the above silent time reminding device, which can be solely used or co-used with a soft and elastically extensible fastening band. The silent time reminding device can be associated with the fastening band or detached therefrom. By means of the fastening band, the silent time reminding device can be located on a suitable part of a user's body. After the silent time reminding device is detached from the fastening band, a user can still wear the fastening band without feeling uncomfortable. Therefore, without the silent time reminding device, the fastening band itself will not become a burden to the user's body.

It is still a further object of the present invention to provide the above silent time reminding device, which can be conveniently carried and solely, independently and popularly used in different situations.

According to the above objects, the silent time reminding device of the present invention includes: a fastening band, which can be fitted on human body, the fastening band having a connected section disposed on an outer face of the fastening band; and a main body having at least one connecting section disposed on an outer face of the main body, the connecting section being easily detachably connectable with the connected section of the fastening band, whereby the main body can contact with a surface of the human body via the fastening band, the main body being at least inbuilt with a timer and a vibration module, the timer serving to drive the vibration module to vibrate at a specific time, whereby the vibration module can shock the surface of the human body to achieve a reminding effect.

A setting key is arranged on an outer face of the main body for a user to adjust operation time of the timer and make other necessary settings.

The present invention can be best understood through the following description and accompanying drawings wherein:

### BRIEF DESCRIPTION OF THE DRAWINGS

FIG. 1 is a perspective exploded view of the present invention;

FIG. 2 is a perspective assembled view of the present invention; and

FIG. 3 is a perspective view showing an application of the present invention.

### DETAILED DESCRIPTION OF THE PREFERRED EMBODIMENTS

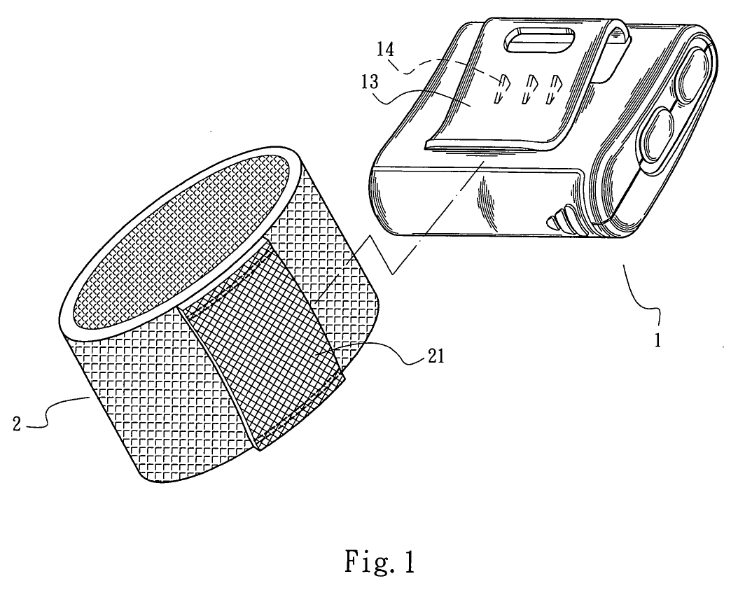

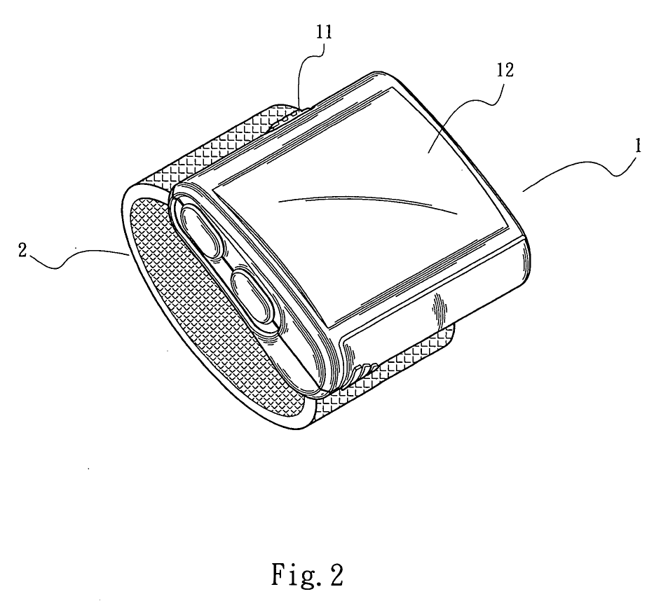

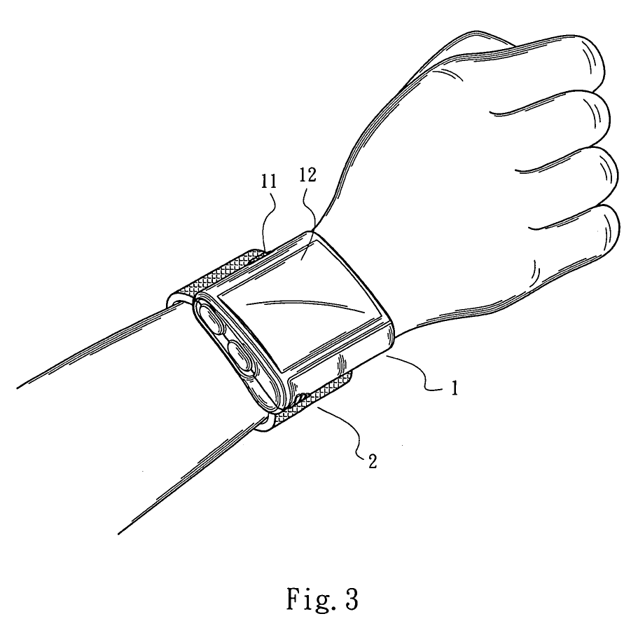

Please refer to FIGS. 1 to 3. The silent time reminding device of the present invention includes a main body 1 and a fastening band 2. The main body 1 is at least inbuilt with a timer and a vibration module (neither is shown). The time and the vibration module pertain to prior art, which have been widely applied to various electronic products. The timer serves to drive the vibration module to vibrate at a preset specific time. A display screen 12 and at least one setting key 11 are respectively arranged on a front face and a lateral side of the main body 1. The setting key 11 is for a user to adjust the operation time of the timer and make other necessary settings. The display screen 12 serves to display the setting and operation states. In addition, a backside of the main body 1 is provided with a connecting section. As shown in the figures, the connecting section is a resilient clip 13. Several abutment sections 14 are disposed on an outer face of the main body 1 between the main body 1 and the resilient clip 13. The fastening band 2 is soft and elastically extensible for fitting on a suitable part of human body, such as a wrist or an ankle. A connected section is disposed on an outer face of the fastening band 2. As shown in the figures, the connected section is a clipped section 21. Two opposite sides of the clipped section 21 are sown on the fastening band 2, while two other opposite sides of the clipped section 21 are open. The clipped section 21 and the fastening band 2 define a pocket.

In use, the resilient clip 13 is extended into the pocket. At this time, the abutment sections 14 and the resilient clip 13 cooperatively clip the clipped section 21 to firmly detachably associate the main body 1 with the fastening band 2. When wearing the fastening band 2, the main body 1 keeps in contact with a surface of a user's body. When the timer in the main body 1 counts to the preset time input via the setting key 11, the vibration module is driven to vibrate. At this time, the main body 1 vibrates and shocks the part of the user's body to solely remind the user without affecting others. The silent time reminding device of the present invention has relatively simple structure and is conveniently portable and operable. Also, the silent time reminding device of the present invention can be more reliably used so that the reminding function can be ensured.

According to the above arrangement, by means of the fastening band 2, the main body 1 can be positioned on a part (such as a limb) of a user's body directly in contact with a surface thereof. However, the main body 1 is easily detachable from the fastening band 2. Therefore, alternatively, the main body 1 can be directly solely placed in a position adjacent to the user's body, such as a place under a pillow or the like. Accordingly, the silent time reminding device of the present invention can be more widely used in different manners. The fastening band 2 is a soft and elastically extensible member. Accordingly, after the main body 1 is detached from the fastening band 2, a user can still wear the fastening band 2 without feeling uncomfortable. Therefore, without the main body 1 of the silent time reminding device, the fastening band 2 itself will not become a burden to the user's body. In the above embodiment, the main body 1 is associated with the fastening band 2 by means of the resilient clip 13 and the clipped section 21. In practice, the main body 1 can be associated with the fastening band 2 by any other measure, which is able to securely detachably associate the main body with the fastening band 2.

In conclusion, the silent time reminding device of the present invention has simple structure and is manufactured at low cost. In addition, the silent time reminding device of the present invention can be conveniently used without interfering with any other people. Also, the main body of the silent time reminding device can be easily separated from the fastening band and solely used.

The above embodiments are only used to illustrate the present invention, not intended to limit the scope thereof. Many modifications of the above embodiments can be made without departing from the spirit of the present invention.

What is claimed is:

1. A silent time reminding device comprising:
a fastening band, which can be fitted on human body, the fastening band having a connected section disposed on an outer face of the fastening band; and
a main body having at least one connecting section disposed on an outer face of the main body, the connecting section being easily detachably connectable with the connected section of the fastening band, whereby the main body can be immediately close to or contact with a surface of the human body, the main body being at least inbuilt with a timer and a vibration module, the timer serving to drive the vibration module to vibrate at a specific time, whereby the vibration module can shock the surface of the human body to achieve a reminding effect.

2. The silent time reminding device as claimed in claim 1, wherein the connected section is a sheet-shaped clipped section, two opposite sides of the clipped section being sown on the fastening band, while two other opposite sides of the clipped section are open, whereby the clipped section and the fastening band define a pocket, the connecting section being a resilient clip, the resilient clip being extendable into the pocket to clip the clipped section so as to firmly detachably associate the main body with the fastening band.

3. The silent time reminding device as claimed in claim 2, wherein at least one abutment section is disposed on an outer face of the main body between the main body and the resilient clip, whereby when the resilient clip is extended into the pocket, the abutment section abuts against the clipped section and cooperates with the resilient clip to tightly clip the clipped section.

4. The silent time reminding device as claimed in claim 1, wherein a setting key is arranged on an outer face of the main body for a user to adjust operation time of the timer and make other necessary settings.

5. The silent time reminding device as claimed in claim 2, wherein a setting key is arranged on an outer face of the main body for a user to adjust operation time of the timer and make other necessary settings.

6. The silent time reminding device as claimed in claim 3, wherein a setting key is arranged on an outer face of the main body for a user to adjust operation time of the timer and make other necessary settings.

7. The silent time reminding device as claimed in claim 1, wherein the fastening band is elastically extensible.

8. The silent time reminding device as claimed in claim 2, wherein the fastening band is elastically extensible.

9. The silent time reminding device as claimed in claim 3, wherein the fastening band is elastically extensible.

10. The silent time reminding device as claimed in claim 4, wherein the fastening band is elastically extensible.

11. The silent time reminding device as claimed in claim 5, wherein the fastening band is elastically extensible.

12. The silent time reminding device as claimed in claim 6, wherein the fastening band is elastically extensible.
